(19) United States
(12) Patent Application Publication
(10) Pub. No.: US 2024/0300728 A1
(43) Pub. Date: Sep. 12, 2024

(54) SYSTEMS, METHODS, AND COMPONENTS ASSOCIATED WITH ELECTROCHROMIC PREFORMS

(71) Applicant: SAGE ELECTOCHROMICS, INC., Faribault, MN (US)

(72) Inventor: Clifford Lee TAYLOR, Nerstrand, MN (US)

(21) Appl. No.: 18/666,537

(22) Filed: May 16, 2024

Related U.S. Application Data
(62) Division of application No. 16/655,338, filed on Oct. 17, 2019.
(60) Provisional application No. 62/746,727, filed on Oct. 17, 2018.

(51) Int. Cl. B65D 85/38; B65D 25/10; B65D 57/00; B65D 81/05; B65D 85/48; F16B 2/22

(52) U.S. Cl. CPC B65D 85/38; B65D 25/103; B65D 57/006; B65D 81/055; B65D 85/48; F16B 2/22; Y10T 24/44368; Y10T 24/44564

(57) ABSTRACT

A system for containing electrochromic preforms comprising: a rigid structure defining a compartment; and a vapor barrier disposed within the compartment and adapted to define a selectively sealable internal volume, wherein a plurality of electrochromic preforms are receivable in the internal volume, and wherein the internal volume defines a reference tool for aligning at least one of the plurality of electrochromic preforms. A component adapted to couple with an edge of an electrochromic preform comprising: a body defining an electrochromic preform engagement portion and a tool engagement portion pivotally coupled with the electrochromic preform engagement portion, wherein reducing a dimension of the tool engagement portion increases a corresponding dimension in the electrochromic preform engagement portion.

### CROSS-REFERENCE TO RELATED APPLICATIONS

This application is a divisional application of and claims priority under 35 U.S.C. § 121 to U.S. patent application Ser. No. 16/655,338, entitled “SYSTEMS, METHODS, AND COMPONENTS ASSOCIATED WITH ELECTROCHROMIC PREFORMS,” by Clifford Lee Taylor, filed Oct. 17, 2019, which claims priority under 35 U.S.C. § 119(c) to U.S. Provisional Application No. 62/746,727, entitled “SYSTEMS, METHODS, AND COMPONENTS ASSOCIATED WITH ELECTROCHROMIC PREFORMS,” by Clifford Lee Taylor, filed Oct. 17, 2018, all of which are assigned to the current assignee hereof and incorporated herein by reference in their entireties for all purposes.

### FIELD OF THE DISCLOSURE

The present disclosure relates to electrochromic preforms, and more particularly to systems, methods, and components associated with electrochromic preforms.

### RELATED ART

Electrochromic devices generally include an electrochromic element that can be selectively tinted between various states of light transmissibility. Electrochromic devices are particularly effective as windows in buildings, such as commercial and residential buildings, as they allow an operator, such as a room occupant or building supervisor, to quickly and precisely adjust room ambience.

Windows vary considerably both in their shape and size. Accordingly, electrochromic devices for windows must be made to fit various shaped and sized openings. Building operators, owners, and occupants continue to demand improved systems and methods for electrochromic devices, particular for fabrication and installation of the electrochromic devices.

### BRIEF DESCRIPTION OF THE DRAWINGS

Embodiments are illustrated by way of example and are not intended to be limited in the accompanying figures.

FIGS. 1 to 5 include perspective views of systems in accordance with embodiments described herein during loading of electrochromic preforms.

FIG. 6 includes a cross-sectional view of a component adapted to be installed on an edge of an electrochromic preform in accordance with an embodiment.

FIG. 7 includes a perspective view of the component in accordance with an embodiment.

FIG. 8 includes a top view of the system in accordance with an embodiment with electrochromic preforms disposed therein.

FIG. 9 includes an expanded top view of the system in FIG. 8, as seen in circle A.

FIG. 10 includes a perspective view of a plurality of systems disposed inside a container for shipping in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The terms “generally,” “substantially,” “approximately,” and the like are intended to cover a range of deviations from the given value. In a particular embodiment, the terms “generally,” “substantially,” “approximately,” and the like refer to deviations in either direction of the value within 10% of the value, within 9% of the value, within 8% of the value, within 7% of the value, within 6% of the value, within 5% of the value, within 4% of the value, within 3% of the value, within 2% of the value, or within 1% of the value.

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the electrochromic arts.

In accordance with an aspect, a system for containing an electrochromic preform can include a rigid structure defining a compartment and a vapor barrier disposed within the compartment and adapted to define a selectively scalable internal volume adapted to receive the electrochromic preform. In an embodiment, the rigid structure can have a multi-piece construction. In another embodiment, the rigid structure can be reusable. In certain instances, the internal volume can be adapted to receive a plurality of electrochromic preforms. The system can further include a reference tool adapted for aligning at least one of the plurality of electrochromic preforms. In a particular instance, the reference tool can be used to align a first electrochromic preform of the plurality of electrochromic preforms. Subsequent electrochromic preforms can be aligned relative to the first electrochromic preform.

In accordance with another aspect, a component adapted to couple with an edge of an electrochromic preform can include a body defining an electrochromic preform engagement portion and a tool engagement portion coupled with the electrochromic preform portion. In an embodiment, the electrochromic preform engagement portion can be pivotally coupled with the tool engagement portion. In a particular instance, reducing a dimension of the tool engagement portion can increase a corresponding dimension in the electrochromic preform engagement portion. An operator, machine, or robot can thus selectively adjust the electrochromic preform engagement portion to install the component relative to the edge of the electrochromic preform. After installation, the operator, machine, or robot can release the component, leaving the component coupled with the edge of the electrochromic preform.

In accordance with a further aspect, a method of transporting an electrochromic preform can include, at a first location, moving the electrochromic preform toward a selectively scalable internal volume defined by a vapor barrier. The method can further include sealing the selectively scalable internal volume with the electrochromic preform inside and transporting the electrochromic preform to a secondary location. In an embodiment, the internal volume can be adapted to receive a plurality of electrochromic preforms. In a particular embodiment, the electrochromic preforms can be devoid of bus bars or otherwise be non-operational.

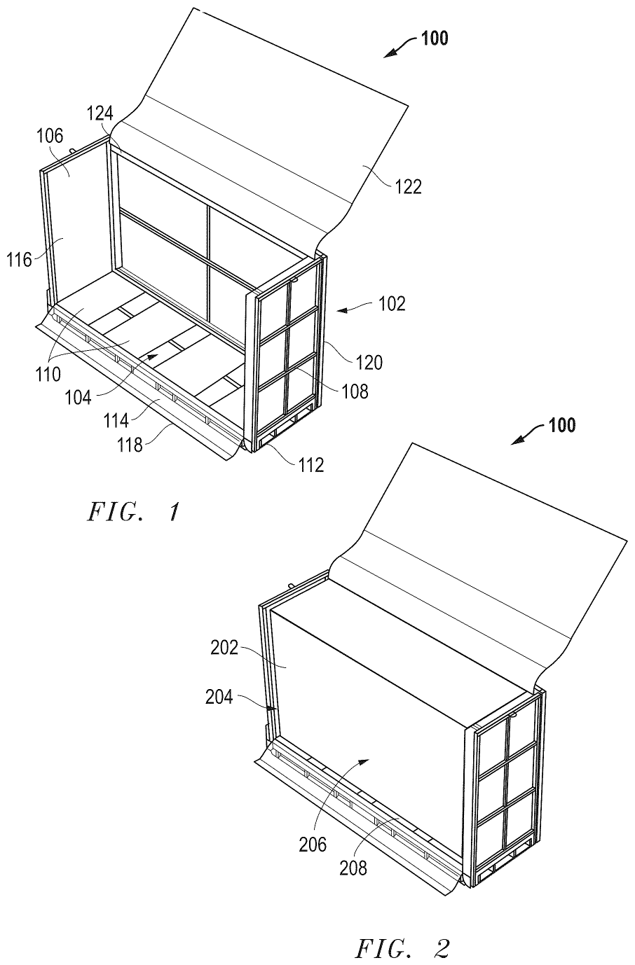

FIG. 1 illustrates a system 100 for containing electrochromic preforms in accordance with an embodiment. The system 100 is illustrated in FIG. 1 empty-without electrochromic preforms. The system 100 can generally include a rigid structure 102 defining a compartment 104. In an embodiment, the rigid structure 102 can include at least 6 major sidewalls. In a more particular embodiment, the rigid structure 102 can define a generally cuboidal shape. In an embodiment, the compartment 104 can have a volume of at least 0.15 m², at least 0.25 m², at least 0.5 m², at least 0.75 m², at least 1 m², at least 2 m², or at least 3 m². In certain instances, the compartment 104 can have a shape that is the same as, or generally similar to, the shape of the rigid structure 102. In an embodiment, the compartment 104 can include one or more objects extending from the rigid structure 102 into the compartment 104, such as for example, stays, supports, dividers, tie anchors, or any combination thereof.

In an embodiment, the rigid structure 102 can have a multi-piece construction including a plurality of discrete elements coupled together. For instance, in an embodiment, the rigid structure 102 can include one or more sidewalls 106 and a frame 108. The one or more sidewall 106 can have same or similar shapes, compositions, sizes, dimensions, features, or any combination thereof as compared with respect to one another. In an embodiment, at least one of the sidewalls 106 can be supported by the frame 108. In an embodiment, at least one of the sidewalls 106 can be coupled with the frame 108. By way of non-limiting example, the sidewalls 106 and frame 108 can be coupled together by threaded or non-threaded fasteners, clips, ties, brackets, adhesives, interference fit, or any combination thereof. In a more particular embodiment, a plurality of sidewalls 106, such as all of the sidewalls 106 can be coupled with the frame 108. In another embodiment, at least one of the sidewalls 106 can float relative to the frame 108. For example, the sidewalls 106 can be non-fixedly coupled with the frame 108, such as leaned against the frame 108.

In certain instances, the rigid structure 102 can be collapsible, foldable, or otherwise deformable between an in-use configuration and a not-in-use configuration. In such a manner, the rigid structure 102 can be transported or stored empty with a reduced volumetric footprint.

In an embodiment, a bottom surface 112 of the rigid structure 102 can include a reinforcement, such as a reinforced frame, additional framing, or a combination thereof. In a particular embodiment, the bottom surface 112 of the rigid structure 102 can include an area adapted to receive arms of a tool, such as a forklift, for moving the system 100. In certain instances, the system 100 can be adapted to be transported with a manually operated tool, such as a forklift. In another instance, the system 100 can be adapted to be transported by an autonomous vehicle, such as a robot. In certain embodiments, the system 100 can include indicia, features, or other elements adapted to align the autonomous robot with respect to the system 100.

One or more pads 110 can be disposed within the compartment 104, such as along, or adjacent to, one or more of the major surfaces of the rigid structure 102, such as for example, along the bottom surface 112 of the rigid structure 102. The one or more pads 110 can include dampening elements, cushions, supports, or any combination thereof. In certain instances, at least one of the one or more pads 110 can include a coating applied to the pad 110. The coating can include a material adapted to increase a coefficient of friction of the pad 110. In certain instances, the coating can include a high friction coating adapted to prevent slipping of the electrochromic preforms (described in greater detail below).

In an embodiment, at least one of the one or more pads 110 can have a generally cuboidal shape. In another embodiment, at least one of the one or more pads 110 can have a shape including contours, such as ridges, crests, castellations, nobs, indents, other shaped surfaces, or any combination thereof. In such a manner, the pad 110 can define discrete storage areas for receiving the electrochromic preform (described in greater detail below).

In the illustrated embodiment, the bottom surface 112 of the rigid structure 102 includes a plurality of pads 110 disposed in the compartment 104 and equally spaced apart from one another. The plurality of pads 110 are illustrated all having a same size and shape. In a non-illustrated embodiment, at least two of the pads 110 can have different sizes or shapes as compared to one another. In another embodiment, at least two sets of pads 110 can be spaced apart from one another by different distances. For instance, a first set of pads can be interspaced by a first distance different from a second distance between a second set of pads. In a further embodiment, a first set of pads can be disposed at a different relative angle with respect to a second set of pads. In certain instances, at least one of the one or more pads 110 can be coupled with the rigid support 102. For instance, the at least one pad 110 can be coupled with one or more of the sidewalls 106, the frame 108, or a combination thereof. By way of non-limiting example, the at least one pad 110 can be coupled to the sidewall 106, the frame 108, or both by a threaded or non-threaded fastener, clips, ties, brackets, adhesives, interference fit, or any combination thereof.

In an embodiment, at least one of the one or more pads 110 can have a density no greater than 15 lbs/ft³, no greater than 10 lbs/ft³, no greater than 8 lbs/ft³, no greater than 6 lbs/ft³, no greater than 4 lbs/ft³, no greater than 2 lbs/ft³, or no greater than 1 lbs/ft³. In another embodiment, at least one of the one or more pads 110 can include foam. In a particular embodiment, at least one of the one or more pads 110 can include open cell foam. In another particular embodiment, at least one of the one or more pads 110 can include closed fell foam. Exemplary foams include compressed or densified polyester, low density polyurethane foam, medium density polyurethane foam, high density polyurethane foam, dry fast open cell foam, polyethylene foam, or any combination thereof.

FIG. 1 illustrates the rigid structure 102 in accordance with an embodiment in an open configuration whereby the rigid structure 102 is adapted to receive a load of transportable elements, such as electrochromic preforms described in greater detail below. In an embodiment, the rigid structure 102 can be opened by pivoting a cover 120 from a closed position to an open position to reveal the compartment 104. In a particular embodiment, the cover 120 can be adapted to pivot at least 10°, at least 15°, at least 20°, at least 25°, at least 30°, at least 45°, at least 60°, at least 90°, at least 120°, or at least 180º. In another particular embodiment, the cover 120 can be adapted to pivot no greater than 300°, no greater than 270°, or no greater than 240°.

In a particular embodiment, the cover 120 can be adapted to remain coupled with at least one of the sidewalls 106 when the rigid structure 102 is open and adapted to receive transportable elements. In certain instances, the rigid structure 102 can further include a front portion 122 (FIG. 3) adapted to be selectively opened to reveal the compartment 104. In certain instances, at least one of the sidewalls 106, such as for example, the front portion 122, can include a multi-piece construction. In an embodiment, at least one of the sidewalls 106 can include at least two discrete components coupled together. In an embodiment, the front portion 122 can include a first portion 122A and a second portion 122B (FIG. 4). In a particular embodiment, the first and second portions 122A and 122B can have a same shape, a same size, or a combination thereof. In a particular instance, the first and second portions 122A and 122B can be installed or removed separately, such as successively, to open and close the rigid structure 102.

In an embodiment, opening the rigid structure 102 can be performed by removing, deforming, translating, pivoting, or otherwise operating on at least a portion of at least one of the sidewalls 106 of the rigid structure 102, at least a portion of at least two of the sidewalls 106 of the rigid structure 102, or at least a portion of at least three of the sidewalls 106 of the rigid structure 102. For example, in a particular embodiment, the cover 120 can be pivoted between open and closed positions and another sidewall 106 of the rigid structure 102 can be removed therefrom to permit access to the compartment 104. In an embodiment, at least one of the sidewalls 106 (optionally including the cover 120) can be coupled together by one or more fasteners (not illustrated), including, for example, one or more hinges, locks, snap fit components, threaded or non-threaded fasteners, bayonet connections, hooks, splines, clips, latches, rings, stapes, bands, ties, or any combination thereof. In certain instances, all of the sidewalls 106 can be coupled together by a common fastener type. In other instances, at least one of the sidewalls 106 (such as the cover 120) can be coupled to at least one of the other sidewalls 106 by a unique fastener type.

In an embodiment, the system 100 can further include a vapor barrier 114 adapted to be disposed in the compartment 104 of the rigid structure 102. In certain instances, the vapor barrier 114 can include a discrete element adapted to fit inside the compartment 104. In other instances, the vapor barrier 114 can be integral with the rigid structure 102.

In an embodiment, the vapor barrier 114 can be waterproof. In another embodiment, the vapor barrier 114 can be greaseproof. In a further embodiment, the vapor barrier 114 can be flexible. In yet a further embodiment, the vapor barrier 114 can be heat-scalable. In yet another embodiment, the vapor barrier 114 can be waterproof, greaseproof, flexible, heat-scalable, or any combination thereof.

In certain instances, the vapor barrier 114 can define a shape similar, or generally similar, to the shape of the compartment 104 of the rigid structure 102. In an embodiment, the vapor barrier 114 can be shaped to have a close fit with the rigid structure 102. In certain instances, the vapor barrier 114 can include shaped sections (not illustrated) adapted to conform to the shape of the rigid structure 102 or other components of the system 100, such as for example, the one or more pads 110. For example, in an embodiment, at least one of the one or more pads 110 is disposed between the vapor barrier 114 and the rigid structure 102. The vapor barrier 114 can include recessed portions adapted to contour to the shape of the one or more pads 110.

In an embodiment, the vapor barrier 114 can define a wall thickness in a range of 1 mil and 100 mil, as measured according to ASTM D2103, in a range of 2 mil and 75 mil, in a range of 3 mil and 60 mil, in a range of 4 mil and 40 mil, in a range of 5 mil and 25 mil, or in a range of 6 mil and 10 mil. In a more particular embodiment, the vapor barrier 114 can define a wall thickness of approximately 7 mil.

In an embodiment, the vapor barrier 114 can define a tensile strength of at least 10 lbs/in, as measured according to ASTM D882, at least 15 lbs/in, at least 20 lbs/in, or at least 25 lbs/in. In another embodiment, the vapor barrier 114 can define a tensile strength of no greater than 100 lbs/in, no greater than 75 lbs/in, or no greater than 50 lbs/in.

In an embodiment, the vapor barrier 114 can have an oxygen transmission rate (OTR) in a range of 0.0001 cc/100 in²/day and 0.001 cc/100 in²/day, as measured according to ASTM D3985, or in a range of 0.0004 cc/100 in²/day and 0.0006 cc/100 in²/day. In another embodiment, the vapor barrier 114 can have an OTR of at least 0.0001 cc/100 in²/day, at least 0.0002 cc/100 in²/day, at least 0.0003 cc/100 in²/day, at least 0.0004 cc/100 in²/day, or at least 0.0005 cc/100 in²/day. In a further embodiment, the vapor barrier 114 can have an OTR no greater than 0.005 cc/100 in²/day, no greater than 0.004 cc/100 in²/day, no greater than 0.003 cc/100 in²/day, no greater than 0.002 cc/100 in²/day, or no greater than 0.001 cc/100 in²/day.

In an embodiment, the vapor barrier 114 can have a water vapor transmission rate (WVTR) in a range of 0.0001 cc/100 in²/day and 0.001 cc/100 in²/day, as measured according to ASTM F1249, or in a range of 0.0004 cc/100 in²/day and 0.0006 cc/100 in²/day. In another embodiment, the vapor barrier 114 can have a WVTR of at least 0.0001 cc/100 in²/day, at least 0.0002 cc/100 in²/day, at least 0.0003 cc/100 in²/day, at least 0.0004 cc/100 in²/day, or at least 0.0005 cc/100 in²/day. In a further embodiment, the vapor barrier 114 can have a WVTR no greater than 0.005 cc/100 in²/day, no greater than 0.004 cc/100 in²/day, no greater than 0.003 cc/100 in²/day, no greater than 0.002 cc/100 in²/day, or no greater than 0.001 cc/100 in²/day. In certain instances, the vapor barrier 114 can be impermeable. In other instances, the vapor barrier 114 can be semi-permeable.

In an embodiment, the vapor barrier 114 can include a plastic sheet, a foil sheet, or a combination thereof. In an embodiment, the vapor barrier 114 can have a homogenous composition. In another embodiment, the vapor barrier 114 can have a layered composition, including for example, a laminate having a substrate and a vapor impermeable (or semi-permeable) layer. In an embodiment, the vapor barrier 114 can include a polymer, a metal, an alloy, a fibrous material, or any combination thereof.

The vapor barrier 114 can define an internal volume 116 when installed within the rigid structure 102. In an embodiment, the internal volume 116 can have a same, or generally same, shape or size as compared to the compartment 104. In another embodiment, the internal volume 116 can have a different shape or size as compared to the compartment 104. In certain instances, the vapor barrier 114 can be coupled with the rigid structure 102, such as coupled with the sidewall 106 or the frame 108, at one or more locations. In other instances, the vapor barrier 114 can float relative to the rigid structure 102. That is, for example, the vapor barrier 114 can be disposed within the compartment 104 and not be coupled with the rigid structure 102.

In an embodiment, the vapor barrier 114 can define a scalable edge 118 adapted to be selectively sealed to create a sealed internal volume 116. In certain instances, the sealable edge 118 can include an adhesive, a bonding intermediary adapted to enhance sealing, a different characteristic as compared to other portions of the vapor barrier 114, or any combination thereof. In an embodiment, the sealable edge 118 can extend continuously along one edge of the vapor barrier 114, such as along a lower edge.

In an embodiment, the vapor barrier 114 can include a cover 122. The cover 122 can be reconfigurable between open and closed positions to permit selective sealing of the sealable edge 118 therewith. In an embodiment, the cover 122 of the vapor barrier 114 can be disposed adjacent the cover 120 of the rigid structure 102. In a more particular embodiment, the cover 122 can be adapted to pivot at a location adjacent to a cover 120 pivot point. In yet a more particular embodiment, the cover 122 of the vapor barrier 114 can be adapted to remain adjacent to the cover 120 of the rigid structure 102 when in the open configuration.

In an embodiment, the vapor barrier 114 can define one or more seams, pleats, folds, or other shaped portions adapted to permit close fit contact between the vapor barrier 114 and the transportable element, such as one or more electrochromic preforms.

In an embodiment, the system 100 can further include a reference tool 124 adapted to align at least one of the transportable elements adapted to be stored within the system 100. In certain instances, the reference tool 124 can be adapted to guide a machine transporting the transportable elements. In a more particular instance, the reference tool 124 can be adapted to guide the transportable elements and align them with respect to the internal volume 116. In yet a more particular instance, the reference tool 124 can be adapted to permit autonomous alignment of the transportable elements with respect to the system 100.

In an embodiment, the reference tool 124 can include a picture frame disposed along or adjacent to one or more sidewalls 106 of the system 100. In a particular embodiment, the reference tool 124 can include a generally polygonal structure, a generally arcuate structure, or a structure having arcuate and polygonal sections. In a particular instance, the reference tool 124 can include a color, texture, indicia, feature, or any combination thereof adapted to be recognized by a detection element, such as a sensor, on a machine transporting the transportable elements, such as electrochromic preforms, to the system 100. The reference tool 124 can be coupled with one or more sidewalls 106 of the system 100. In a particular instance, the reference tool 124 can be coupled along an interior surface of the sidewalls 106. In a more particular instance, the reference tool 124 can be disposed within the compartment 104 of the rigid structure 102. In an embodiment, the reference tool 124 is disposed within the interior volume 116 of the vapor barrier 114. In another embodiment, the reference tool 124 is disposed between the vapor barrier 114 and at least a portion of the rigid structure 102.

In an embodiment, the reference tool 124 is disposed along a best fit plane adapted to be parallel, or generally parallel, with a best fit plane of at least one of the transportable elements when properly oriented and contained within the internal volume 116. In a more particular embodiment, the reference tool 124 can lie along a best fit plane adapted to be parallel, or generally parallel, with a best fit plane of at least one of the electrochromic preforms adapted to be transported by the system 100.

Referring to FIG. 2, the system 100 can be adapted to receive a plurality of electrochromic preforms 202. As used herein, electrochromic preforms 202 include portions of electrochromic devices. More particularly, electrochromic preforms can include nonfunctional portions of electrochromic devices. Yet more particularly, electrochromic preforms can include portions of electrochromic devices devoid of bus bars or other hardware or elements necessary for proper utilization of the electrochromic device.

In accordance with an embodiment described herein, the system 100 can be adapted to transport electrochromic preforms from a first location to a second location. Typically, transportation of electrochromic devices is performed only after the electrochromic device is fully manufactured (i.e., after the electrochromic device is operable). Transportation of electrochromic preforms is difficult given the sensitive nature of unfinished depositions, layers, and elements. Systems 100 in accordance with embodiments described herein can mitigate difficulties associated with sensitive elements of the electrochromic preform.

In an embodiment, the system 100 can be adapted to receive at least 2 electrochromic preforms, at least 5 electrochromic preforms, at least 10 electrochromic preforms, at least 25 electrochromic preforms, or at least 50 electrochromic preforms. In another embodiment, the system 100 can be adapted to receive no greater than 200 electrochromic preforms, no greater than 150 electrochromic preforms, no greater than 100 electrochromic preforms, or no greater than 75 electrochromic preforms.

The plurality of electrochromic preforms 202 can be stacked relative to one another such that best fit planes of each of the plurality of electrochromic preforms 202 extend parallel, or generally parallel, with respect to one another. In an embodiment, moving the electrochromic preforms 202 into the internal volume 116 can be performed in a direction normal, or generally normal, with a best fit plane of the electrochromic preforms 202. For example, referring again to FIG. 1, the electrochromic preforms 202 can be moved in a direction toward the reference tool 124. After an initial electrochromic preform 202 is in position within the internal volume 116, a subsequent electrochromic preform 202 can be introduced in a similar manner. The subsequent electrochromic preform 202 can be aligned with the reference tool 124, the initial electrochromic preform 202, another intermediary electrochromic preform 202 disposed between the initial electrochromic preform 202 and the subsequent electrochromic preform 202, or any combination thereof.

In an embodiment, at least two sets of electrochromic preforms can be equally spaced apart from one another. In another embodiment, at least one electrochromic preform 202 can be spaced apart from the system 100 by a different distance as compared to a spacing between adjacent electrochromic preforms 202. For instance, in an embodiment, the electrochromic preforms 202 can include a first electrochromic preform, a third electrochromic preform, and a second electrochromic preform disposed between the first and third electrochromic preforms. A nearest distance between the first electrochromic preform and the system 100 (e.g., the reference tool 124 or sidewall 106) can be different than a distance between the second and third electrochromic preforms. In a particular embodiment, the distance between the first electrochromic preform 202 and the system 100 can be less than the distance between adjacent electrochromic preforms. In another particular embodiment, the distance between the first electrochromic preform 202 and the system 100 can be greater than the distance between adjacent electrochromic preforms 202.

In an embodiment, at least one of the electrochromic preforms 202 is adapted to be contacted along an edge 204 thereof. In a more particular embodiment, at least one of the electrochromic preforms 202 is adapted to contact only along the edge 204. That is, for example, a middle portion 206 of the electrochromic preform 202 can be spaced apart from any other electrochromic preform 202 or other portion of the system 100. In certain instances, the electrochromic preforms 202 can be coupled with one or more components 208 disposed around the edge 204 thereof. In a particular embodiment, the one or more components 208 includes a plurality of components 208 adapted to contact each of the electrochromic preforms, such as at least two components, at least three components, at least four components, at least five components, at least six components, at least eight components, at least ten components, at least twenty components, or at least fifty components. In another embodiment, the plurality of components can include no greater than 500 components, no greater than 250 components, or no greater than 100 components. In an embodiment, the components can be spaced apart from one another. In a more particular embodiment, the components can be equally spaced apart from one another. In an embodiment, the components 208 can be positioned at same positions along the edges 204 of at least two of the electrochromic preforms 202. That is, for example, at least two of the electrochromic preforms 202 can have components 208 disposed at same, or generally same, locations therealong. In such a manner, the components 208 can be positioned adjacent to one another when the plurality of electrochromic preforms are disposed within the internal volume 116.

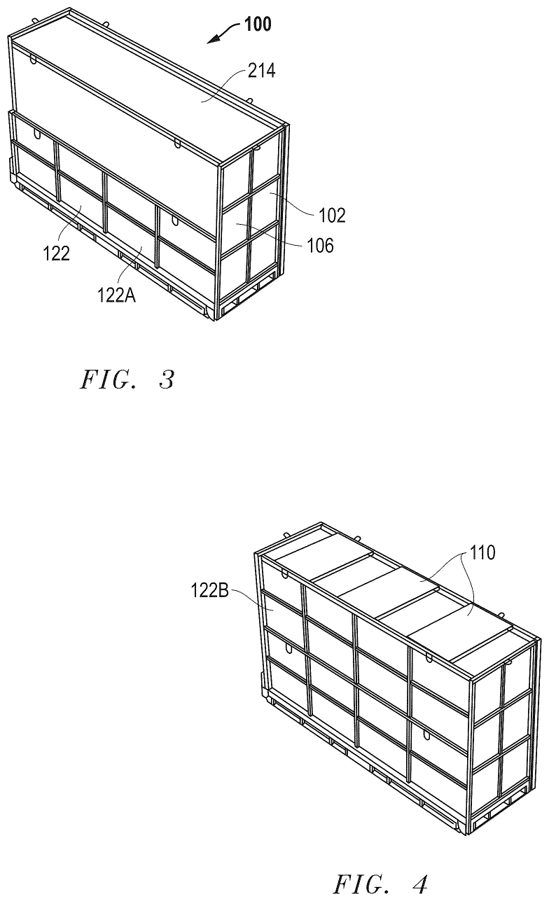

Referring to FIG. 6, at least one of the components 208 can include a body 602 defining an electrochromic preform engagement portion 604 adapted to engage with the electrochromic preform 202 and a tool engagement portion 606. In an embodiment, the electrochromic preform engagement portion 604 can be pivotally coupled with the tool engagement portion 606. In a particular instance, the tool engagement portion 606 can be adapted to receive a biasing force from an operator, a tool, or a combination thereof, to decrease a dimension, D_{TEG}, of the tool engagement portion 606. Decreasing the dimension, D_{TEG}, of the tool engagement portion 606 can increase a corresponding dimension, D_{EPEP}, of the electrochromic preform engagement portion 604. In an embodiment, D_{TEG} and D_{EPEP} are parallel, or generally parallel, with one another. In a more particular embodiment, D_{TEG} and D_{EPEP} define widths of the component 208. In an embodiment, D_{TEG} and D_{EPEP} are uniform, or generally uniform, along a majority, such as an entire, length of the component 208.

In an embodiment, the electrochromic preform engagement portion 604 can include a receiving area 608 disposed between a first sidewall 610 and a second sidewall 612. The receiving area 608 can be adapted to receive at least one of the electrochromic preforms 202. In a more particular embodiment, the receiving area 608 can be adapted to receive one of the electrochromic preforms 202. In certain instances, the dimension, D_{EPEP}, of the electrochromic preform engagement portion 604 can be greater than a thickness, T_{EP}, of the electrochromic preform 202, as measured prior to engagement with the electrochromic preform 202.

In an embodiment, at least one of the first and second sidewalls 610 and 612 of the electrochromic preform engagement portion 604 can include a flange 614 disposed at or adjacent to a distal end 616 of the component 208. In a particular embodiment, the first and second sidewalls 610 and 612 can both include a flange 614 disposed at or adjacent to the distal end 616.

In an embodiment, the flange 614 of the first sidewall 610 can extend radially inward. In a more particular embodiment, the flange 614 can be canted relative to the first sidewall 610. In a more particular embodiment, the flange 614 can be canted away from an opening 620 of the receiving area 608. For example, in an embodiment, the flange 614 can be disposed along a best fit line disposed at an angle, Ar, as measured with respect to the first sidewall 610, less than 90°, less than 85°, less than 80°, less than 75°, less than 70°, less than 65°, or less than 60°. In another embodiment, the angle, Ar, can be no less than 10°, no less than 15°, no less than 20°, no less than 25°, or no less than 30°.

In an embodiment, the flange 614 can be adapted to guide the electrochromic preform into the receiving area 208. In an embodiment, the flange 614 can include a rounded end, a tapered end, or any combination thereof.

In an embodiment, the electrochromic preform engagement portion 604 can include a plurality of projections 618 extending into the receiving area 608. In an embodiment, at least one of the plurality of projections 618 can extend from the first sidewall 610 and at least one of the plurality of projections 618 can extend from the second sidewall 612. In a particular embodiment, the first and second sidewalls 610 and 612 can include different numbers of projections 618 as compared to one another. In another particular embodiment, the first and second sidewalls 610 and 612 can include a same number of projections 618 as compared to one another. In a particular instance, the projections 618 can be similarly positioned along the first and second sidewalls 610.

In an embodiment, at least one of the plurality of projections 618 can be canted relative to the first or second sidewall 610 or 612. In a more particular embodiment, at least one of the projections, such as a first set of projections 618A, a second set of projections 618B, a third set of projections 618C, or any combination thereof, can be canted away from the opening 620 of the receiving area 608.

In an embodiment, at least one of the plurality of projections 618 can be disposed at an angle, A_{P}, as measured by an angle of a best fit line with respect to the first sidewall 610, less than 90°, less than 85°, less than 80°, less than 75°, less than 70°, less than 65°, or less than 60°. In another embodiment, the angle, A_{P}, can be no less than 10°, no less than 15°, no less than 20°, no less than 25°, or no less than 30°. In an embodiment, A_{P} is in a range of 1° and 89°, in a range of 5° and 88°, in a range of 20° and 85°, or in a range of 60° and 80°.

In an embodiment, the angle, A_{P}, of the projection 618 can be different than the angle, A_{F}, of the flange 614. In a particular embodiment, A_{P} can be less than A_{F}. In another particular embodiment, A_{F} can be less than A_{P}. In yet another embodiment, the angle, A_{P}, of the projection 618 can be the same, or generally the same as the angle, A_{F}, of the flange 614.

In an embodiment, all of the plurality of projections 618 can be disposed at the angle, A_{P}, where A_{P} is less than 90°, less than 85°, less than 80°, less than 75°, less than 70°, less than 65°, or less than 60°. In another embodiment, the angle, A_{P}, can be no less than 10°, no less than 15°, no less than 20°, no less than 25°, or no less than 30°.

In an embodiment, at least two of the plurality of projections 618 can extend the same distance into the receiving area 608, as measured from the first or second sidewalls 610 or 612 when the component 208 is not coupled with an electrochromic preform 202. In another embodiment, at least two sets of projections (e.g., sets of projections 618A, 618B, and 618C) can extend the same distance into the receiving area 608. In a more particular embodiment, all of the plurality of projections 618 can extend the same distance into the receiving area 608.

In another embodiment, at least two of the plurality of projections 618 can extend different distances into the receiving area 608. In another embodiment, at least two sets of projections (e.g., sets of projections 618A, 618B, and 618C) can extend different distances into the receiving area 608. In a more particular embodiment, all of the plurality of projections 618 can extend different distances into the receiving area 608.

In an embodiment, the flange 614 on the first sidewall 610 can extend a distance, D_{F}, into the receiving area 608 and at least one of the projections 618 can extend a distance, D_{P}, into the receiving area 608. In a particular embodiment, De can be in a range of 0.1 D_{P} and 2.0 D_{P}, in a range of 0.5 D_{P} and 1.25 D_{P}, in a range of 0.75 D_{P} and 1.1 D_{P}, or in a range of 0.9 D_{P} and 1.05 D_{P}.

In an embodiment, at least one of the projections 618 can have a tapered cross-sectional profile. For instance, the at least one projection 618 can define a first thickness, as measured adjacent to the first or second sidewall 610 or 612, and a second thickness, as measured at a location spaced apart from the first or second sidewall 610 or 612, different than the first thickness. In a more particular embodiment, the first thickness can be greater than the second thickness. In a particular instance, the at least one projection 618 can define a linear (e.g., constant) taper. In another instance, the at least one projection 618 can define a non-constant taper.

In certain instances, at least one of the projections 618 can include a deformable material, such as an elastomer, adapted to deform upon insertion of the electrochromic preform 202 into the receiving area 608. In an embodiment, at least one of the projections 618 can include, for example, ethylene propylene diene monomer (EPDM), silicone, butyl, isoprene, styrene-butadiene (SBR), butadiene, isobutylene, fluorocarbon, fluoroelastomer (FKM), natural rubber, butyl rubber, isobutylene isoprene rubber (IIR), acrylonitrile butadiene rubber (NBR), chloroprene rubber (CR), chlorosulfonated polyethylene (CSM), or any combination thereof. In another embodiment, at least one of the projections 618 can include a nylon, a polyether ether ketone (PEEK), polyether sulfone (PES), polytetrafluoroethylene (PTFE), polyimide, or an organic or inorganic composite. Further exemplary polymers include fluorinated ethylene-propylene (FEP), polyvinylidenfluoride (PVDF), polychlorotrifluoroethylene (PCTFE), ethylene chlorotrifluoroethylene (ECTFE), perfluoroalkoxy alkane (PFA), polyacetal, polybutylene terephthalate (PBT), polyethylene terephthalate (PET), polyimide (PI), polyetherimide, polyethylene (PE), polysulfone, polyamide (PA), polyphenylene oxide, polyphenylene sulfide (PPS), polyurethane, polyester, liquid crystal polymers (LCP), or any combination thereof.

In certain instances, at least one of the projections 618 can include a filler. Exemplary fillers include glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof.

In an embodiment, installation of the component 208 with respect to the electrochromic preform 202 can be performed by translating at least one of the component 208 and electrochromic preform 202 toward one another. The electrochromic preform 202 can pass through the opening 620 of the component 208 into the receiving area 608. In a particular embodiment, the electrochromic preform 202 can be guided into the receiving area by one or both of the flanges 610 and 612. Upon contacting and biasing against an edge set of projections (e.g., projections 618C), the electrochromic preform 202 can deform the projections 618, such as bend at least one of the projections 618, compress at least one of the projections 618, or both. In certain instances, at least one of the sidewalls 610 and 612 can deform outward as the electrochromic preform is inserted into the receiving area 608. In a more particular instance, both of the sidewalls 610 and 612 can deform outward as the electrochromic preform is inserted into the receiving area 608.

In an embodiment, an installation force between the electrochromic preform 202 and component 208 can increase as the electrochromic preform engages with more of the projections 618 (e.g., as the electrochromic preform 202 is inserted further into the receiving area 608). In an embodiment, an engagement force required to install the component 208 relative to the electrochromic preform 202 can be different than a disengagement force required to detach the component 208 from the electrochromic preform 202. In a more particular embodiment, the engagement force can be less than the disengagement force. For instance, the engagement force can be no greater than 0.99 times the disengagement force, no greater than 0.98 times the disengagement force, no greater than 0.97 times the disengagement force, no greater than 0.96 times the disengagement force, no greater than 0.95 times the disengagement force, or no greater than 0.9 times the disengagement force.

In certain instances, the component 208 can further include a stop feature 622 adapted to prevent over insertion of the electrochromic preform 202 into the receiving area 608. In an embodiment, the stop feature 622 can be disposed within the receiving area 608. In a more particular embodiment, the stop feature 622 can be disposed at a proximal end of the receiving area 608. In yet a more particular embodiment, the stop feature 622 can be disposed adjacent to the tool engagement portion 606, such as adjacent to a pivot point 624 between the electrochromic preform engagement portion 604 and the tool engagement portion 606.

In an embodiment, the stop feature 622 can include a material having a Shore A hardness less than the body 602 of the component 208. In a more particular embodiment, the stop feature 622 can include a deformable material, such as an elastomer. The stop feature 622 can include, for instance, any one or more of the polymers described with respect to the projections 618. For example, the stop feature 622 can include ethylene propylene diene monomer (EPDM), silicone, butyl, isoprene, styrene-butadiene (SBR), butadiene, isobutylene, fluorocarbon, fluoroelastomer (FKM), natural rubber, butyl rubber, isobutylene isoprene rubber (IIR), acrylonitrile butadiene rubber (NBR), chloroprene rubber (CR), chlorosulfonated polyethylene (CSM), or any combination thereof. In an embodiment, the stop feature 622 can include a filler, such as glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. In certain instances, the stop feature 622 and at least one of the projections 618 can have a same material composition. In another embodiment, the stop feature 622 and at least one of the projections 618 can have different material compositions as compared to one another.

In an embodiment, the tool engagement portion 606 can include a first biasing surface 626 and a second biasing surface 628. The first and second biasing surfaces 626 and 628 can be adapted to engage with a tool (not illustrated) adapted to bias the biasing surfaces 626 and 628 relative to one another, such as compress the biasing surfaces 626 and 628 together. As illustrated, in an embodiment, the first and second biasing surfaces 626 and 628 can extend from the pivot point 624 in directions generally parallel with respect to one another.

In an embodiment, at least one of the biasing surfaces 626 and 628 can include a flange 630 disposed adjacent to a distal end of the at least one biasing surface 626 or 628. In a particular embodiment, at least one of the flanges 630 can extend along a best fit line normal with the at least one of the first and second biasing surfaces 626 or 628. In an embodiment, the component 208 can include a flange 630 disposed on the first biasing surface 626 and a flange 630 disposed on the second biasing surface 628. In a particular instance, the flanges 630 and 630 can extend inward, toward one another. In another embodiment, at least one of the flanges 630 or 630 can extend outward, away from the other flange 630.

In certain instances, the tool engagement portion 606 can further include a deformable element 632 disposed between the first and second biasing surfaces 626 and 628. In a particular embodiment, the deformable element 632 can be disposed adjacent, or generally adjacent, to the pivot point 624. In a particular embodiment, the deformable element 632 can be disposed at, or adjacent, to a proximal end of the tool engagement portion 606. In a particular instance, the stop feature 622 and deformable element 632 can be spaced apart from one another by a portion of the body 602. In a more particular instance, the stop feature 622 and deformable element 632 can be spaced apart by a portion of the body 602 corresponding with the pivot point 624.

In an embodiment, the deformable element 632 can be adapted to bias the first and second biasing surfaces 626 and 628 apart from one another. In a more particular embodiment, the deformable element 632 can be adapted to increase a biasing force required to compress the first and second biasing surfaces 626 and 628 together. In an embodiment, the deformable element 632 comprises a deformable material. In a more particular embodiment, the deformable element 632 can include a material described with respect to the stop feature 622. For example, the deformable element 632 can include ethylene propylene diene monomer (EPDM), silicone, butyl, isoprene, styrene-butadiene (SBR), butadiene, isobutylene, fluorocarbon, fluoroelastomer (FKM), natural rubber, butyl rubber, isobutylene isoprene rubber (IIR), acrylonitrile butadiene rubber (NBR), chloroprene rubber (CR), chlorosulfonated polyethylene (CSM), or any combination thereof.

In certain instances, the tool engagement portion 606 can be shaped to receive an operating portion of a tool (not illustrated) adapted to bias the tool engagement portion 606 to affect the relative dimensions of the electrochromic preform engagement portion 604. For instance, the tool engagement portion 606 can have a shape adapted to receive or secure relative to biasing fingers of the tool.

In an embodiment, the electrochromic preform engagement portion 604 can extend a different distance from the pivot point 624 than the tool engagement portion 606. In a more particular embodiment, in a particular embodiment, the electrochromic preform engagement portion 604 can extend a greater distance from the pivot point 624 than the tool engagement portion 606. For instance, the electrochromic preform engagement portion 604 can extend at least 1.1 times further from the pivot point 624 than the tool engagement portion 606, at least 1.2 times further from the pivot point 624 than the tool engagement portion 606, at least 1.3 times further from the pivot point 624 than the tool engagement portion 606, at least 1.4 times further from the pivot point 624 than the tool engagement portion 606, at least 1.5 times further from the pivot point 624 than the tool engagement portion 606, or at least 2 times further from the pivot point 624 than the tool engagement portion 606. In another instance, the electrochromic preform engagement portion 604 can extend no greater than 10 times further from the pivot point 624 than the tool engagement portion 606, no greater than 8 times further from the pivot point 624 than the tool engagement portion 606, no greater than 6 times further from the pivot point 624 than the tool engagement portion 606, or no greater than 4 times further from the pivot point 624 than the tool engagement portion 606.

In an embodiment, at least one of the electrochromic preform engagement portion 604 and tool engagement portion 606 can be reflectively symmetrical. In a more particular embodiment, both the electrochromic preform engagement portion 604 and the tool engagement portion 606 can be reflectively symmetrical.

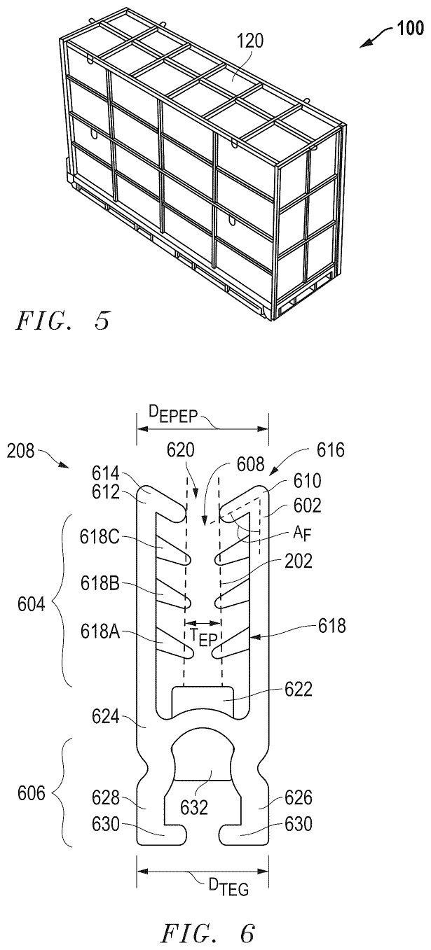

Referring to FIG. 7, in an embodiment, the component 208 can have a uniform, or generally uniform, composition, shape, size, or any combination thereof, as measured along the entire length of the component 208. In a particular embodiment, the component 208 can have a length, L_{C}, less than an edge length, L_{E}, of the electrochromic preform 202. Thus, for example, the component 208 can be adapted to be positioned along a portion of an edge of the electrochromic preform 202. In an embodiment, the electrochromic preform 202 can be adapted to receive a plurality of components 208. In a more particular embodiment, the electrochromic preform 202 can be adapted to receive a plurality of components 208 along each edge thereof.

In certain instances, the component 208 can include an extruded body 602. In an embodiment, the body 602 comprises a resilient material. For example, the body 602 can include a material having a Shore A durometer greater than the projections 618. Exemplary materials include high-density polyethylene (HDPE), polypropylene (PP), polyvinyl chloride (PVC), polystyrene (PS), nylon, polytetrafluorocthylene (PTFE), polyurethane (PU), and combinations thereof. In a particular embodiment, the body 602 comprises polypropylene.

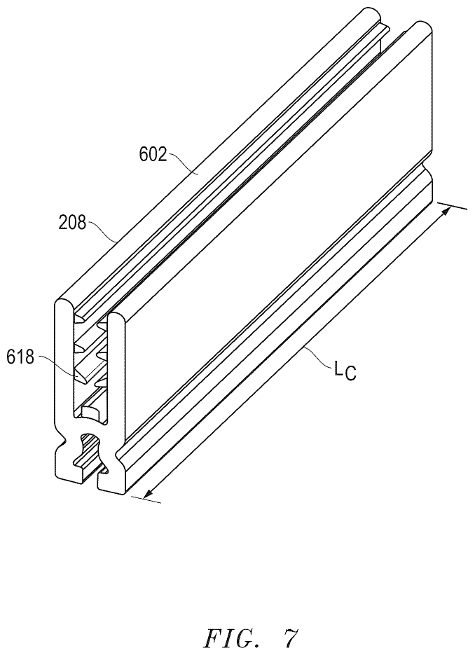

In an embodiment, the electrochromic preforms 202 are adapted to be equally spaced apart within the compartment 206 of the rigid system 202. Referring to FIG. 8, the electrochromic preforms 202 can be adapted to be oriented in a same direction when disposed in the compartment 206. In a more particular embodiment, the electrochromic preforms 202 can be disposed at same relative positions as compared to one another within the compartment 206, with adjacent electrochromic preforms 202 translated apart from one another in a direction normal to the major surfaces thereof. In such a manner, the edges of the electrochromic preforms 202 can be aligned with one another, such as aligned along a plane perpendicular to a major surface of the electrochromic preforms 202. Further, major surfaces of the electrochromic preforms 202 can be oriented parallel with respect to one another.

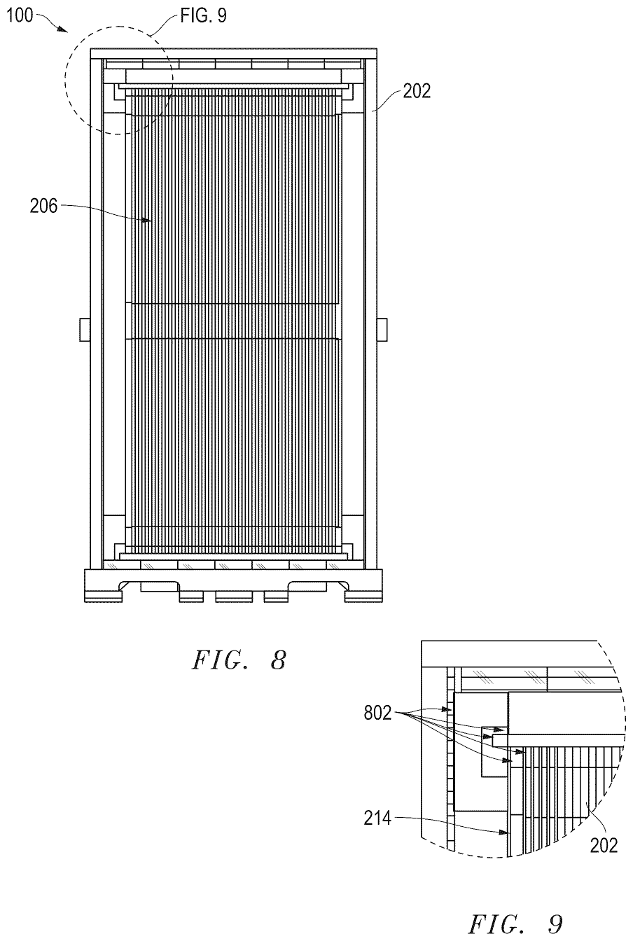

Prior to sealing the vapor barrier 214 (performed prior to the embodiment illustrated in FIG. 3), one or more pads 802 can be installed relative to the electrochromic preforms 202 to dampen vibration or prevent relative movement within the compartment 206. Referring to FIG. 9, the one or more pads 802 can include pads 802 disposed outside of the vapor barrier 214, inside the vapor barrier 214, or a combination thereof. Pads 802 disposed within the vapor barrier 214 can be positioned prior to sealing the vapor barrier 214. Internal pads (i.e., pads 802 within the vapor barrier 214) can be disposed, for example, between adjacent electrochromic preforms 202, along edges of at least one of the electrochromic preforms 202, or along a major surface of an outer electrochromic preform 202. In an embodiment, the pads 802 can include a same material as the one or more pads 110 previously described. In another embodiment, the pads 802 can include a different material as compared to the one or more pads 110. In an embodiment, at least one of the pads 802 can be coupled with the rigid structure 102, such as along sidewalls 106, such that the at least one pad 802 remains in contact with the rigid structure 102 when electrochromic preforms 202 are absent from the system 100.

In an embodiment, the electrochromic preforms 202 can be pressure loaded by the system 100. That is, for example, the system 100 can include one or more components (such as the pads 110 and 802) adapted to compress and support the electrochromic preforms 202 to further mitigate motion thereof, particularly during transit. In an embodiment, the internal volume 116, V_{MIN}, of the vapor barrier 214, as measured when the vapor barrier 214 is in close fit communication with the compartment 106 of the rigid structure 102 in an unbiased condition, can be different than the internal volume, V_{EP}, when the internal volume 116 is full of electrochromic preforms 202. In a more particular embodiment, V_{MIN} can be less than V_{EP}. For instance, V_{MIN} can be less than 0.99 V_{EP}, less than 0.98 V_{EP}, less than 0.97 V_{EP}, less than 0.96 V_{EP}, less than 0.95 V_{EP}, less than 0.94 V_{EP}, less than 0.93 V_{EP}, less than 0.92 V_{EP}, less than 0.91 V_{EP}, or less than 0.9 V_{EP}. In another embodiment, V_{MIN} can be less than 0.85 V_{EP}, less than 0.8 V_{EP}, less than 0.75 V_{EP}, less than 0.7 V_{EP}, less than 0.65 V_{EP}, less than 0.6 V_{EP}, less than 0.55 V_{EP}, or less than 0.5 V_{EP}. In yet another embodiment, V_{MIN} can be no less than 0.1 V_{EP}, no less than 0.2 V_{EP}, no less than 0.3 V_{EP}, or no less than 0.4 V_{EP}.

A desiccant (not illustrated) can be included in the system 100, such as within the internal volume 116 of the vapor barrier 214. The desiccant can include a hygroscopic substance adapted to induce or sustain a state of dryness within the internal volume 116. In an embodiment, the desiccant can be chemically inert. In another embodiment, the desiccant can include, for instance, a silica, a charcoal, an activated charcoal, calcium sulfate, calcium chloride, molecular sieves, or any combination thereof. In an embodiment, the desiccant can be inserted into the internal volume 116 prior to sealing the vapor barrier 214. In an embodiment, the desiccant can include a plurality of desiccant containing bodies disposed around the internal volume 116, such as within different areas of the internal volume 116.

FIG. 3 illustrates the system 100 after sealing the vapor barrier 214 and installing a first portion 122A of a sidewall 106 of the rigid structure 102. FIG. 4 illustrates the system 100 with a plurality of pads 110 disposed along an upper surface of the system 100. In an embodiment, the pads 110 are installed opposite the one or more pads 110 described with respect to FIG. 1. In an embodiment, the pads 110 are the same, or generally the same, as the one or more pads 110 previously described. In another embodiment, the pads 110 are different than the one or more pads 110 previously described in at least one of size, shape, composition, and spatial arrangement relative to the electrochromic preforms 202. FIG. 5 illustrates the system 100 after securing the cover 120. One or more ties, bands, or compression elements (not illustrated) can be wrapped around the system 100 or any portion thereof.

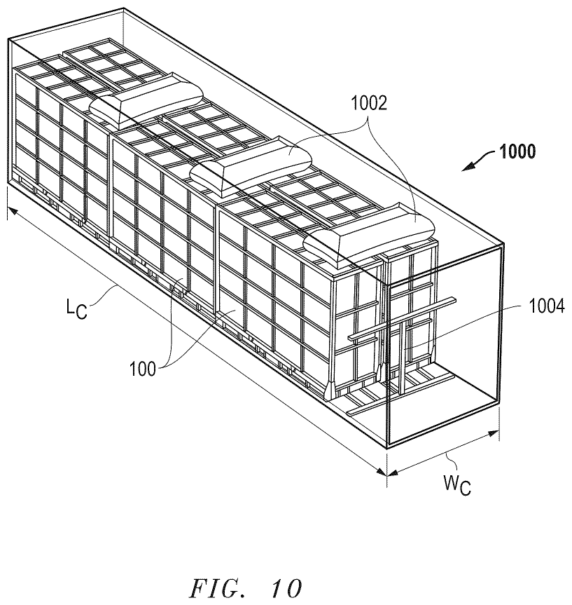

As illustrated in FIG. 5, the system 100 is ready for transport. For example, the system 100 can be transported to a second location where the electrochromic preforms 202 can be further operated on, such as customized on-site or at a local facility for particular window installation. In certain instances, the system 100 can be adapted to be transported by rail, car, plane, or boat. In an embodiment, a plurality of systems 100 can be adapted to fit within a container, such as the container 1000 illustrated in FIG. 10. In the illustrated embodiment, the container 1000 can be adapted to receive a plurality of systems 100 each containing a plurality of electrochromic preforms 202. In an embodiment, the container 1000 can be adapted to receive at least two systems 100, at least three systems 100, at least four system 100, at least five systems 100, or at least six systems 100. In another embodiment, the container 1000 can be adapted to receive no greater than 20 systems 100, no greater than 10 systems 100, or no greater than 8 systems 100.

In an embodiment, the container 1000 can have a width, W_{C}, greater than a width, W_{S}, of the system 100 to be received therein. In a particular embodiment, W_{C} can be at least 1.01 W_{S}. In a more particular embodiment, W_{C} can be in a range between 1.9 W_{S} and 4 W_{S}, in a range of 1.95 W_{S} and 2.5 W_{S}, or in a range of 1.99 W_{S} and 2.25 W_{S}. In a particular instance, We can be approximately equal to 2 W_{S}. In such a manner, the container 1000 can be adapted to contain at least two systems 100 disposed next to one another in a width direction of the container 1000.

In an embodiment, the container 1000 can have a length, L_{C}, greater than a length, L_{S}, of the system 100 to be received therein. In a particular embodiment, L_{C} can be at least 1.01 L_{S}. In a particular embodiment, L_{C} can be in a range between 1.01 L_{S} and 10 L_{S}, in a range of 1.5 L_{S} and 5 L_{S}, or in a range of 2 L_{S} and 4 L_{S}. In such a manner, the container 1000 can be adapted to contain at least two systems next to one another in a length direction of the container 1000.

In an embodiment, the container 1000 can have a height, H_{C}, greater than a height, H_{S}, of the system 100 to be received therein. In a particular embodiment, H_{C} can be at least 1.01 H_{S}. In a particular embodiment, He can be in a range between 1.01 H_{S} and 10 H_{S}, in a range of 1.1 H_{S} and 2 H_{S}, or in a range of 1.3 H_{S} and 1.75 H_{S}.

In an embodiment, a plurality of systems 100 can be loaded into the container 1000. In a particular embodiment, the plurality of systems 100 can be secured by ties, stays, or other means to prevent relative movement within the container 1000. In another embodiment, the plurality of systems 100 can be loaded into the container 1000 in a close-fit therewith to avoid movement due to compression or close fit arrangement. In an embodiment, the systems 100 are disposed within the container 1000 such that they dampen vibration and movement within the container 1000. For instance, the loaded container 1000 can have a reduced resonance frequency as compared to an unloaded container or a partially loaded container. In certain instances, the loaded container 1000 can incur a reduced maximum G force on the electrochromic preforms 202, thereby further reducing the possibility of damage during shipping.

In certain instances, one or more expandable objects 1002, such as inflatable bags, can be positioned between adjacent systems 100 and 100, systems 100 and the container 1000, or both. In a particular embodiment, the expandable objects 1002 can include dunnage bags. The expandable objects 1002 can be positioned within the container 1000 after the systems 100 are disposed therein. In an embodiment, the systems 100 can be supported by an internal framework 1004 disposed within the container 1000. In a particular instance, the framework 1004 can be secured to the container 1000. In another instance, the framework 1004 can float relative to the container 1000 (e.g., the framework 1004 can be unsecured to the container 1000). In a particular embodiment, the framework 1004 can include portions disposed between adjacent systems 100.

In certain instances, the container 1000 can be used for shipping systems 100 from a first location to a second location, such as from a first fabrication plant to a second fabrication plant. When shipping from the first location to the second location, the container 1000 can be loaded with systems 100 containing electrochromic preforms 202 which can be offloaded at the second location.

Upon arrival, the systems 100 can be removed from the container 1000, the rigid structure 102 can be opened, and the vapor barrier 214 can be opened to expose the electrochromic preforms 202. In an embodiment, opening the system 100, such as opening the vapor barrier 214, can be performed in a clean environment. In a more particular embodiment, opening the vapor barrier 214 can be performed in a room having a particle count less than the ambient environment, such as a clean room, or a semi-clean room.

In an embodiment, electrochromic preforms 202 can be removed from the system 100 in a manner opposite their insertion therein. For instance, the last electrochromic preform 202 to be loaded into the system 100 can be removed first and the first electrochromic preform 202 loaded into the system 100 can be removed last. After removing the electrochromic preforms 202, the system 100 can be reused, such as broken down for shipping and sent to the original location to receive a plurality of new electrochromic preforms 202.

In an embodiment, the container 1000 can be returned to the first location to receive systems 100 with additional electrochromic preforms 202. In certain instances, the systems 100 can be included in the return shipment from the second location to the first location. In an embodiment, at least one of the systems 100 can be empty during the return shipment. In a more particular embodiment, all of the systems 100 can be empty during the return shipment. In certain instances, at least one of the systems 100 can be at least partially disassembled for the return shipment to permit additional space within the container 1000. In a more particular embodiment, all of the systems 100 can be at least partially disassembled for the return shipment.

Embodiment 1. A component adapted to couple with an edge of an electrochromic preform comprising: a body defining an electrochromic preform engagement portion and a tool engagement portion pivotally coupled with the electrochromic preform engagement portion, wherein reducing a dimension of the tool engagement portion increases a corresponding dimension in the electrochromic preform engagement portion.

Embodiment 2. The component of embodiment 1, wherein the electrochromic preform engagement portion comprises a receiving area adapted to receive the electrochromic preform, and a plurality of projections extending into the receiving area.

Embodiment 3. The component of embodiment 2, wherein at least one of the projections comprises a deformable material, such as an elastomer.

Embodiment 4. The component of any one of embodiments 2 and 3, wherein at least one of the projections lies along a best fit line disposed at an angle, as measured with respect to a sidewall of the component, in a range of 1° and 89°, in a range of 5° and 88°, in a range of 20° and 85°, or in a range of 60° and 80°.

Embodiment 5. The component of any one of embodiments 2-4, wherein at least two projections of the plurality of projections extend a same distance from the sidewall of the component into the receiving area.

Embodiment 6. The component of any one of embodiments 2-5, wherein at least two projections of the plurality of projections extend different distances from the sidewall of the component into the receiving area.

Embodiment 7. The component of any one of embodiments 2-6, wherein the receiving area further comprises a stop feature adapted to prevent over insertion of the electrochromic preform into the receiving area.

Embodiment 8. The component of embodiment 7, wherein the stop feature comprises a deformable material, such as an elastomer.

Embodiment 9. The component of any one of embodiments 7 and 8, wherein the stop feature is disposed adjacent to a pivot point between the electrochromic preform engagement portion and the tool engagement portion.

Embodiment 10. The component of any one of embodiments 2-9, wherein the electrochromic preform engagement portion comprises a first sidewall and a second sidewall spaced apart from one another by the receiving area.

Embodiment 11. The component of embodiment 10, wherein at least one of the sidewalls comprises a flange adjacent to a distal end of the at least one sidewall.

Embodiment 12. The component of embodiment 11, wherein the flange extends radially inward.

Embodiment 13. The component of any one of embodiments 11 and 12, wherein the flange extends a distance, D_{F}, as measured from the sidewall, wherein at least one of the projections extends a distance, D_{P}, and wherein D_{F} is in a range of 0.1 D_{P} and 2.0 D_{P}, in a range of 0.5 D_{P} and 1.25 D_{P}, in a range of 0.75 D_{P} and 1.1 D_{P}, or in a range of 0.9 D_{P} and 1.05 D_{P}.

Embodiment 14. The component of any one of embodiments 11-13, wherein the flange is canted relative to the sidewall.

Embodiment 15. The component of any one of the preceding embodiments, wherein the tool engagement portion comprises a first biasing surface and a second biasing surface, and wherein the biasing surfaces are adapted to engage with a tool adapted to compress the biasing surfaces together.

Embodiment 16. The component of embodiment 15, further comprising a deformable element disposed between the first and second biasing surfaces.

Embodiment 17. The component of any one of embodiments 15 and 16, wherein the deformable element is disposed adjacent to a pivot point between the electrochromic preform engagement portion and the tool engagement portion.

Embodiment 18. The component of any one of embodiments 15-17, wherein at least one of the first and second biasing surfaces comprises a flange disposed adjacent to a distal end of the at least one biasing surface.

Embodiment 19. The component of any one of embodiments 15-18, wherein the flange of the at least one of the first and second biasing surfaces extends along a best fit line normal with the at least one of the first and second biasing surfaces.

Embodiment 20. The component of any one of the preceding embodiments, wherein the electrochromic preform engagement portion extends a greater distance from a pivot point than the tool engagement portion.

Embodiment 21. The component of any one of the preceding embodiments, wherein the component has a reflectively symmetrical cross-sectional profile.

Embodiment 22. The component of any one of the preceding embodiments, wherein the component comprises a body from which the plurality of projections extend from.

Embodiment 23. The component of embodiment 22, wherein the body comprises a first material different than the material of the plurality of projections.

Embodiment 24. The component of any one of embodiments 22 and 23, wherein the body comprises an extruded body.

Embodiment 25. The component of any one of the preceding embodiments, wherein the component comprises a length less than a length of the edge of the electrochromic preform.

Embodiment 26. The component of any one of the preceding embodiments, wherein the component is adapted to be installed relative to the edge of the electrochromic preform by a robot.

Embodiment 27. The component of any one of the preceding embodiments, wherein an engagement force required to install the component relative to the electrochromic preform is less than a disengagement force required to detach the component from the electrochromic preform.

Embodiment 28. A system of framing the electrochromic preform comprising attaching a plurality of components of any one of the preceding embodiment to the edge of the electrochromic preform.

Embodiment 29. The system of embodiment 28, wherein the electrochromic preform is devoid of busbars.

Embodiment 30. A system for containing electrochromic preforms comprising: a rigid structure defining a compartment; and a vapor barrier disposed within the compartment and adapted to define a selectively sealable internal volume, wherein a plurality of electrochromic preforms are receivable in the internal volume, and wherein the internal volume defines a reference tool for aligning at least one of the plurality of electrochromic preforms.

Embodiment 31. The system of embodiment 30, wherein the rigid structure comprises a multi-piece rigid structure including at least 6 sidewalls.

Embodiment 32. The system of any one of embodiments 30 and 31, wherein the rigid structure comprises a cuboidal shape.

Embodiment 33. The system of any one of embodiments 30-32, wherein the rigid structure comprises a rigid skeleton frame and a plurality of generally planar sidewalls.

Embodiment 34. The system of any one of embodiments 30-33, wherein the rigid structure comprises a reinforced bottom adapted to receive arms of a tool, such as a forklift, for moving the system.

Embodiment 35. The system of any one of embodiments 30-34, wherein the vapor barrier is waterproof, greaseproof, flexible, heat-scalable, or any combination thereof.

Embodiment 36. The system of any one of embodiments 30-35, wherein the vapor barrier defines a wall thickness in a range of 1 mil and 100 mil, as measured according to ASTM D2103, in a range of 2 mil and 75 mil, in a range of 3 mil and 60 mil, in a range of 4 mil and 40 mil, in a range of 5 mil and 25 mil, or in a range of 6 mil and 10 mil.

Embodiment 37. The system of any one of embodiments 30-36, wherein the vapor barrier defines a wall thickness of approximately 7 mil, as measured according to ASTM D2103.

Embodiment 38. The system of any one of embodiments 30-37, wherein the vapor barrier defines a tensile strength of at least 10 lbs/in, as measured according to ASTM D882, at least 15 lbs/in, at least 20 lbs/in, or at least 25 lbs/in.

Embodiment 39. The system of any one of embodiments 30-38, wherein the vapor barrier comprises an oxygen transmission rate (OTR) in a range of 0.0001 cc/100 in²/day and 0.001 cc/100 in²/day, as measured according to ASTM D3985, or in a range of 0.0004 cc/100 in²/day and 0.0006 cc/100 in²/day.

Embodiment 40. The system of any one of embodiments 30-39, wherein the vapor barrier comprises a water vapor transmission rate (WVTR) in a range of 0.0001 cc/100 in²/day and 0.001 cc/100 in²/day, as measured according to ASTM F1249, or in a range of 0.0004 cc/100 in²/day and 0.0006 cc/100 in²/day.

Embodiment 41. The system of any one of embodiments 30-40, wherein the vapor barrier is adapted to be selectively sealable upon application of a temperature of at least 400° F., a pressure of at least 40 PSI, for a time of at least 1 second.

Embodiment 42. The system of any one of embodiments 30-41, wherein the vapor barrier comprises a film, a foil, or a laminate.

Embodiment 43. The system of any one of embodiments 30-42, wherein the vapor barrier comprises a polymer, a foil, or a combination thereof.

Embodiment 44. The system of any one of embodiments 30-43, wherein the vapor barrier is adapted to be sealed after insertion of the plurality of electrochromic preforms.

Embodiment 45. The system of any one of embodiments 30-44, wherein, in a closed, unbiased state the internal volume has a volume, V_{MIN}, less than a volume, V_{EP}, of the internal volume when full of electrochromic preforms.

Embodiment 46. The system of embodiment 45, wherein V_{MIN} is less than 0.99 V_{EP}, less than 0.98 V_{EP}, less than 0.97 V_{EP}, less than 0.96 V_{EP}, less than 0.95 V_{EP}, less than 0.94 V_{EP}, less than 0.93 V_{EP}, less than 0.92 V_{EP}, less than 0.91 V_{EP}, or less than 0.9 V_{EP}.

Embodiment 47. The system of any one of embodiments 45 and 46, wherein V_{MIN} is no less than 0.25 V_{EP}, or no less than 0.75 V_{EP}.

Embodiment 48. The system of any one of embodiments 30-47, wherein the internal volume is adapted to receive a plurality of electrochromic preforms, such as at least 2 electrochromic preforms, at least 5 electrochromic preforms, at least 10 electrochromic preforms, at least 25 electrochromic preforms, or at least 50 electrochromic preforms.

Embodiment 49. The system of embodiment 48, wherein the system is adapted to maintain all of the electrochromic preforms at spaced apart intervals.

Embodiment 50. The system of any one of embodiments 48 and 49, wherein all of the electrochromic preforms are adapted to be spaced apart at equal distances.

Embodiment 51. The system of any one of embodiments 30-50, further comprising a component adapted to extend around an edge of all of the electrochromic preforms received in the internal volume.

Embodiment 52. The system of any one of embodiments 30-51, wherein the reference tool is adapted to guide a machine transporting the electrochromic preforms such that the electrochromic preforms are properly aligned with respect to the internal volume.

Embodiment 53. The system of embodiment 52, wherein the reference tool is adapted to autonomously guide the machine transporting the electrochromic preforms.

Embodiment 54. The system of any one of embodiments 52 and 53, wherein the machine comprises a robotic machine.

Embodiment 55. The system of any one of embodiments 52-54, wherein the reference tool comprises a generally polygonal structure, a generally arcuate structure, or a structure having arcuate and polygonal portions.

Embodiment 56. The system of any one of embodiments 52-55, wherein the reference tool comprises a picture frame.

Embodiment 57. The system of any one of embodiments 52-56, wherein the reference tool is disposed along a sidewall of the system.

Embodiment 58. The system of any one of embodiments 52-57, wherein the reference tool is coupled with the sidewall of the system.

Embodiment 59. The system of any one of embodiments 52-58, wherein the reference tool comprises a color, texture, indicia, feature, or any combination thereof adapted to be recognized by a sensor on the machine.

Embodiment 60. The system of any one of embodiments 52-59, wherein the reference tool is disposed along a best fit plane, and wherein the electrochromic preforms are adapted to lie along a best fit plane generally parallel with the best fit plane of the reference tool.

Embodiment 61. The system of any one of embodiments 30-60, wherein the electrochromic preforms are generally planar, and wherein transporting the electrochromic preforms into the internal volume is adapted to be performed in a direction generally normal with the electrochromic preforms.

Embodiment 62. The system of any one of embodiments 30-61, wherein the electrochromic preforms are adapted to be supported by the system along an edge of the electrochromic preforms.

Embodiment 63. The system of any one of embodiments 30-62, wherein the system is adapted to permit flexure of electrochromic preforms contained in the system, and wherein flexure occurs substantially uniformly in all electrochromic preforms disposed in the system upon application of a flexing force to the system.

Embodiment 64. The system of any one of embodiments 30-63, wherein the system is adapted to receive: a first electrochromic preform adjacent to the reference tool, a third electrochromic preform, and a second electrochromic preform disposed between the first and third electrochromic preforms, wherein a nearest distance between the first electrochromic preform and the system is different than a distance between the second and third electrochromic preforms.

Embodiment 65. The system of embodiment 64, wherein the nearest distance between the first electrochromic preform and the system is less than the distance between the second and third electrochromic preforms.

Embodiment 66. The system of any one of embodiments 64 and 65, wherein a distance between the first electrochromic preform and the second electrochromic preform is greater than the nearest distance between the first electrochromic preform and the system.

Embodiment 67. The system of any one of embodiments 30-66, further comprises foam adapted to be disposed around the internal volume.

Embodiment 68. The system of embodiment 67, wherein the foam defines an unbiased, internal volume, as measured in an unloaded state, less than an in-use, internal volume.

Embodiment 69. The system of any one of embodiments 67 and 68, further comprising ties adapted to compress the foam after insertion of the electrochromic preforms into the internal volume.

Embodiment 70. The system of any one of embodiments 30-69, wherein the electrochromic preforms are spaced apart from the vapor barrier and from the multi-piece rigid structure.

Embodiment 71. A method of transporting an electrochromic preform comprising: at a first location, moving the electrochromic preform toward a selectively sealable internal volume defined by a vapor barrier; sealing the selectively sealable internal volume with the electrochromic preform inside; and transporting the electrochromic preform to a secondary location.

Embodiment 72. The method of embodiment 71, wherein moving the electrochromic preform toward the selectively sealable internal volume is performed autonomously.

Embodiment 73. The method of any one of embodiments 71 and 72, wherein moving the electrochromic preform toward the selectively sealable internal volume comprises moving a plurality of electrochromic preforms toward the selectively sealable internal volume.

Embodiment 74. The method of embodiment 73, wherein the plurality of electrochromic preforms comprise at least 2 electrochromic preforms, at least 5 electrochromic preforms, at least 10 electrochromic preforms, at least 25 electrochromic preforms, or at least 50 electrochromic preforms.

Embodiment 75. The method of any one of embodiments 73 and 74, wherein the electrochromic preforms are generally planar, and wherein moving the electrochromic preforms toward the selectively sealable internal volume is performed in a direction generally normal to the generally planar electrochromic preforms.

Embodiment 76. The method of any one of embodiments 71-75, further comprising installing a component with an edge of an electrochromic preform to protect the edge from damage.

Embodiment 77. The method of embodiment 76, wherein installing the component is performed prior to moving the electrochromic preforms toward the selectively sealable internal volume.

Embodiment 78. The method of any one of embodiments 76 and 77, wherein the component comprises a plurality of components adapted to be disposed along the edge of the electrochromic preform.

Embodiment 79. The method of any one of embodiments 71-78, wherein sealing the selectively scalable internal volume is performed at an elevated temperature, an elevated pressure, or both.

Embodiment 80. The method of any one of embodiments 71-79, further comprising installing the vapor barrier in a rigid structure.

Embodiment 81. The method of embodiment 80, wherein transporting the electrochromic preform is performed by loading the rigid structure into a moveable tool, such as a truck, train, airplane, other similar transportation element, or any combination thereof.

Embodiment 82. The method of any one of embodiments 71-81, further comprising removing the electrochromic preform from the internal volume after transporting the electrochromic preform to the secondary location.

Embodiment 83. The method of embodiment 82, further comprising selectively opening the internal volume to expose at least a portion of the electrochromic preform.

Embodiment 84. The method of embodiment 83, wherein selectively opening the internal volume further comprises removing at least a portion of a rigid structure at least partially enclosing the internal volume.

Embodiment 85. The method of embodiment 84, further comprising reusing the rigid structure in a subsequent transportation process.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A system for containing electrochromic devices comprising:
a rigid structure defining a compartment; and
a vapor barrier disposed within the compartment and adapted to define a selectively sealable internal volume, wherein one or more electrochromic devices are receivable in the internal volume.

2. The system of claim 1, wherein the internal volume defines a reference tool for aligning at least one of the one or more electrochromic devices.

3. The system of claim 1, wherein the vapor barrier is greaseproof.

4. The system of claim 1, wherein the rigid structure comprises a multi-piece rigid structure including at least 6 sidewalls.

5. The system of claim 1, wherein the vapor barrier is integral with the rigid structure.

6. The system of claim 1, wherein the vapor barrier is flexible.

7. The system of claim 1, wherein the vapor barrier is heat-sealable.

8. The system of claim 1, further comprising one or more pads disposed between the vapor barrier and the rigid structure.

9. The system of claim 1, wherein the vapor barrier defines a wall thickness in a range of 1 mil and 100 mil, as measured according to ASTM D2103.

10. The system of claim 1, wherein the vapor barrier defines a tensile strength of at least 10 lbs/in, as measured according to ASTM D882.

11. The system of claim 1, wherein the vapor barrier comprises an oxygen transmission rate (OTR) in a range of 0.0001 cc/100 in²/day and 0.001 cc/100 in²/day, as measured according to ASTM D3985.

12. The system of claim 11, wherein the vapor barrier is adapted to be selectively sealable upon application of a temperature of at least 400° F., a pressure of at least 40 PSI, for a time of at least 1 second.

13. The system of claim 11, wherein, in a closed, unbiased state the internal volume has a volume, V_{MIN}, less than a volume, V_{EP}, of the internal volume when full of electrochromic preforms and wherein V_{MIN} is less than 0.99 V_{EP} and no less than 0.25 V_{EP}.

14. The system of claim 11, wherein the vapor barrier a water vapor transmission rate (WVTR) in a range of 0.0001 cc/100 in²/day and 0.001 cc/100 in²/day, as measured according to ASTM F1249.

15. The system of claim 1, wherein the vapor barrier comprises a substrate and a vapor impermeable layer.

16. The system of claim 1, wherein the vapor barrier is floating relative to the rigid structure.

17. The system of claim 11, wherein the system is adapted to receive:
a first electrochromic preform adjacent to the reference tool,
a third electrochromic preform, and
a second electrochromic preform disposed between the first and third electrochromic preforms,
wherein a nearest distance between the first electrochromic preform and the system is different than a distance between the second and third electrochromic preforms.

18. A method of transporting an electrochromic preform comprising:
at a first location, moving the electrochromic preform toward a selectively sealable internal volume defined by a vapor barrier;
sealing the selectively sealable internal volume with the electrochromic preform inside; and
transporting the electrochromic preform to a secondary location.

19. The method of claim 18, wherein moving the electrochromic preform toward the selectively sealable internal volume comprises moving a plurality of electrochromic preforms toward the selectively sealable internal volume and wherein the plurality of electrochromic preforms comprise at least 2 electrochromic preforms.

20. The method of claim 18, wherein the electrochromic preforms are generally planar, and wherein moving the electrochromic preforms toward the selectively sealable internal volume is performed in a direction generally normal to the generally planar electrochromic preforms.
